(19) United States
(12) Patent Application Publication
(10) Pub. No.: US 2013/0248793 A1
(43) Pub. Date: Sep. 26, 2013

(54) Safety Stanchion and Belt Reel

(71) Applicant: David Bar-or, Los Angeles, CA (US)

(72) Inventor: David Bar-or, Los Angeles, CA (US)

(21) Appl. No.: 13/424,864

(22) Filed: Mar. 20, 2012

(51) Int. Cl. G09F 23/00; E04H 17/00

(52) U.S. Cl. 256/59

(57) ABSTRACT

A safety stanchion includes a support base having a vertically extending generally cylindrical post which in turn includes an upper end supporting a belt reel. Within the belt reel, a belt spool having a quantity of flexible belt wound thereon is supported for rotation and spring biased toward a belt rewound configuration. A connector is supported on the outer end of the belt facilitating the withdrawal of a belt portion against the spring force for connection to an adjacent cooperating safety stanchion. The belt reel further defines a plurality of slots each configured to receive corresponding connectors of adjacent safety stanchions to form a pathway or guide for persons within the area. The vertical post is formed of a clear material and a message sleeve bearing a visible message such as direction information or advertising is received within the post.

### FIELD OF THE INVENTION

This invention relates generally to safety and guide stanchions of the type used in airports, stadiums, theatres and other public venues. This invention relates more particularly to the stanchion and belt reel apparatus used in such safety and guide systems.

### BACKGROUND OF THE INVENTION

In many environments attended by large numbers of people such as airports, theatres, sports venues and the like, a need arises to manage the attendees to ensure a smooth trouble-free flow of participation. Often managers of such events and facilities employ systems of organization directed toward guiding attendees into one or more designated lines or cues. In many environments, a flexible easily-changed system is needed to shift and guide the flow of participants between various lines or to open new lines or close existing lines and so on.

One of the most popular attendee management systems utilizes a plurality of stanchions having interconnected pluralities of belts or cords to form pathways. To maintain system flexibility, provision is usually made for connecting and disconnecting belts between stanchions and thus changing the pathways formed by interconnected belts and stanchions. In this manner, one or more attendee lines can be opened while others are closed to route and reroute attendee crowd members as the volume of participant's flows.

Faced with the continuing popularity of such crowd management systems, practitioners in the art have endeavored to provide improved systems which are more cost effective and useful. One of the most popular systems used in a variety of environments provides a plurality of free-standing stanchions each having a support base together with a vertical post extending upwardly from the base. A belt reel is supported upon the upper end of the post. The support base, vertical post and belt wheel combine to form the basic system stanchion. In each belt reel, a belt winding mechanism allows the belt to be wound within the belt reel or drawn from the reel to extend a substantial distance. Each belt is connectable to other belt reels upon other stanchions to provide the desired arrangement or network of guiding paths.

While the foregoing described types of crowd management systems have to some extent improved the art and in some instances enjoyed commercial success, there remains nonetheless a continuing and unresolved need in the art for ever more improved safety stanchions and belt reels.

### SUMMARY OF THE INVENTION

Accordingly, it is a general object of the present invention to provide an improved safety stanchion and belt reel. It is a more particular object of the present invention to provide an improved safety stanchion and belt reel which is easier to assemble and fabricate and which provides additional features and flexibility in use.

In accordance with the present invention, there is provided a safety stanchion comprising: a base; a hollow post formed of a light transmissive material having a first end joined to said base and extending vertically from said base, said post having an upper end and a center passage between said ends; a belt reel having a housing supported upon said upper end and a rotatably supported belt spool within said housing; a length of flexible belt having a first end coupled to said belt spool, a portion wound upon said belt spool and a second end extending outwardly from said housing; a return spring within said housing coupled to said belt spool urging said belt spool toward winding said belt; a belt connector secured to said second end of said flexible belt; and a message element having usable indicia thereon said message element being supported within said center passage such that said visible indicia are visible through said post.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a safety stanchion constructed in accordance with the present invention;

FIG. 2 sets forth an assembly view of the present invention safety stanchion;

FIGS. 3A and 3B set forth section views of the present invention safety stanchion taken along section lines 3-3 in FIG. 2. FIGS. 3A and 3B show alternative embodiments of the present invention;

FIG. 4 sets forth a perspective view of a belt reel constructed in accordance with the present invention;

FIG. 5 sets forth a perspective view of the belt reel of FIG. 4 illustrating the withdraw of a belt portion from the reel;

FIG. 6 sets forth a top view of the belt reel of the present invention safety stanchion;

FIG. 7 sets forth a bottom view of the belt reel shown in FIG. 6;

FIG. 8 sets forth a perspective assembly view of the belt reel of the present invention safety stanchion;

FIG. 9 sets forth a section view of the belt reel of the present invention safety stanchion taken along section lines 9-9 in FIG. 4;

FIG. 10 sets forth a partial section view of the present invention safety stanchion and belt reel showing the stanchion to belt reel attachment;

FIG. 11 sets forth a partial section view of the belt reel of the present invention safety stanchion showing the assembly thereof utilizing a single fastener; and

FIG. 12 sets forth a section view of an alternate embodiment of the present invention safety stanchion showing an alternate single fastener assembly.

### DESCRIPTION OF THE PREFERRED EMBODIMENTS OF THE INVENTION

FIG. 1 sets forth a perspective view of a safety stanchion constructed in accordance with the present invention and generally referenced by numeral 10. Stanchion 10 is shown in a typical arrangement in which a belt is drawn outwardly from stanchion 10 and in which a plurality of belts drawn from other stanchions (not shown) have their respective ends secured to stanchion 10.

More specifically, stanchion 10 includes a support base 11 together with a vertically extending generally cylindrical post 12. In accordance with an important aspect of the present invention, post 12 is formed of a clear transparent material such as clear plastic or the like. In further accordance with an important aspect of the present invention, post 12 further supports a message sleeve 21 within its interior. Message sleeve 21 further supports a visible message 25. Stanchion 10 further includes a belt reel 13 having a quantity of a belt 14 wound therein. Belt 14 defines an outer end secured to a belt connector 15.

In the embodiment of the present invention safety stanchion shown in FIG. 1, stanchion 10 is shown having a quantity of belt 14 drawn outwardly from belt reel 13 in the direction indicated by arrow 16. In the anticipated use of stanchion 10, belt 14 is drawn outwardly from belt reel 13 a sufficient distance to bring belt connector 15 into engagement with the corresponding belt reel portion of an adjacent safety stanchion (not shown). It will be apparent to those skilled in the art that belt connector 15 then engages the belt reel of the adjacent safety stanchion. For purposes of illustration, a pair of belts 17 and 19 having respective belt connectors 18 and 20 are shown extending to belt reel 13 and engaging belt reel 13. Thus as connectors 18 and 20 engage belt reel 13, belts 17 and 19 of adjacent safety stanchions which are identical to stanchion 10, but not shown in FIG. 1, are able to make connections forming elements of a pathway or restricted guide way for event attendees. It will be noted that connector 15 engages the belt reel of an adjacent safety stanchion in a removable engagement in substantially the same manner as belt connectors 18 and 20 engage belt reel 13.

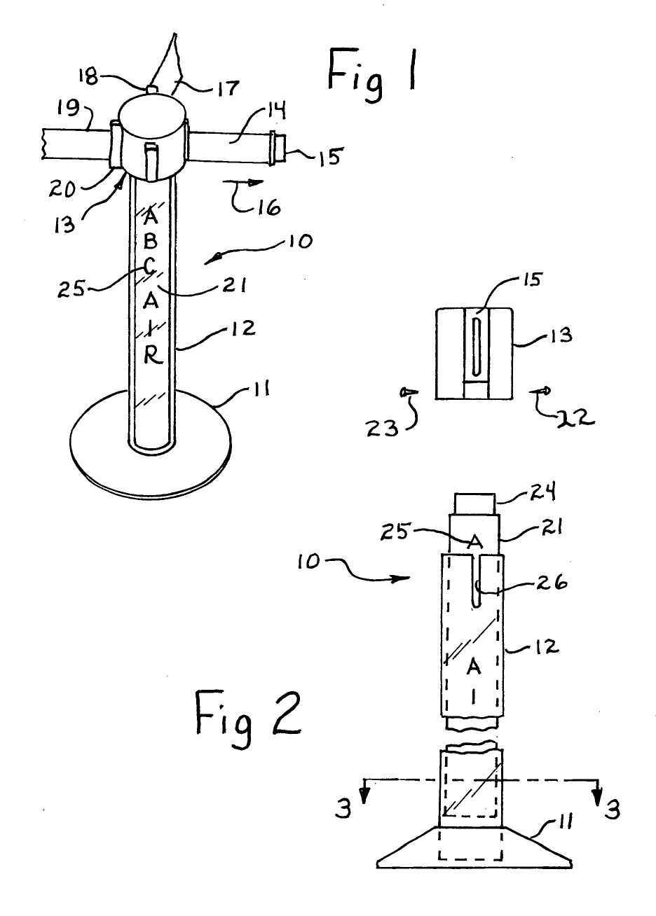

FIG. 2 sets forth an assembly view of safety stanchion 10 showing post 12 assembled to base 11 while message sleeve 21 and support tube 24 are inserted into the interior of post 12. Finally, belt reel 13 is secured upon the upper portion of post 12 using a pair of fasteners 22 and 23.

More specifically, stanchion 10 includes a support base 11 together with a vertically extending generally cylindrical post 12. In accordance with an important aspect of the present invention, post 12 is formed of a clear transparent material such as clear plastic or the like. In further accordance with an important aspect of the present invention, post 12 further supports a message sleeve 21 within its interior. Message sleeve 21 further supports a visible message 25. Stanchion 10 further includes a belt reel 13 having a quantity of a belt 14 wound therein. Belt 14 defines an outer end secured to a belt connector 15.

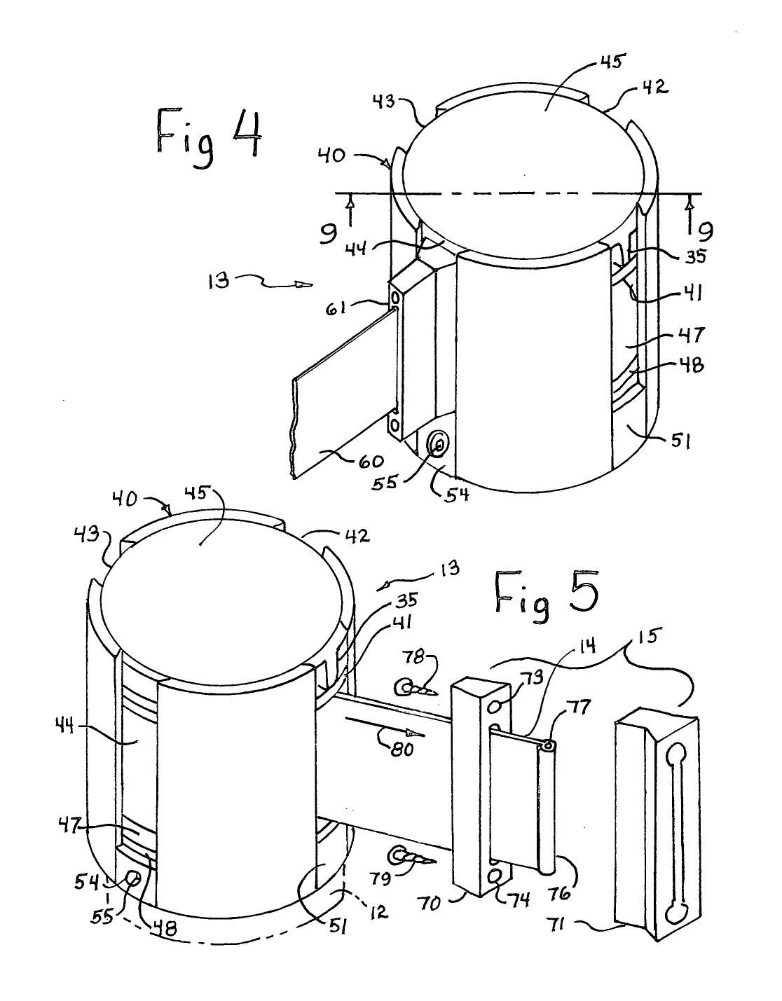

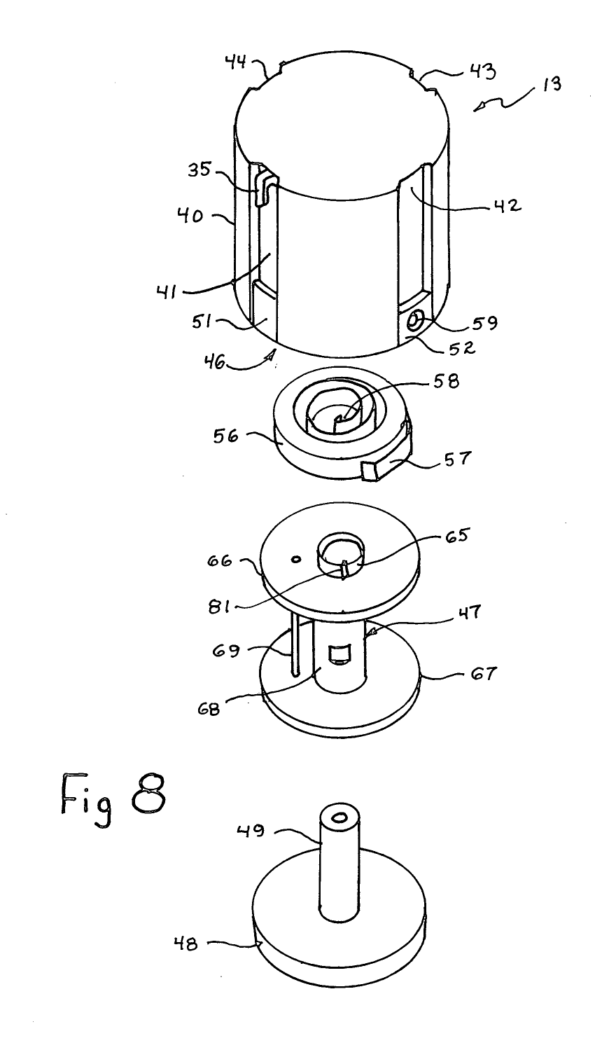

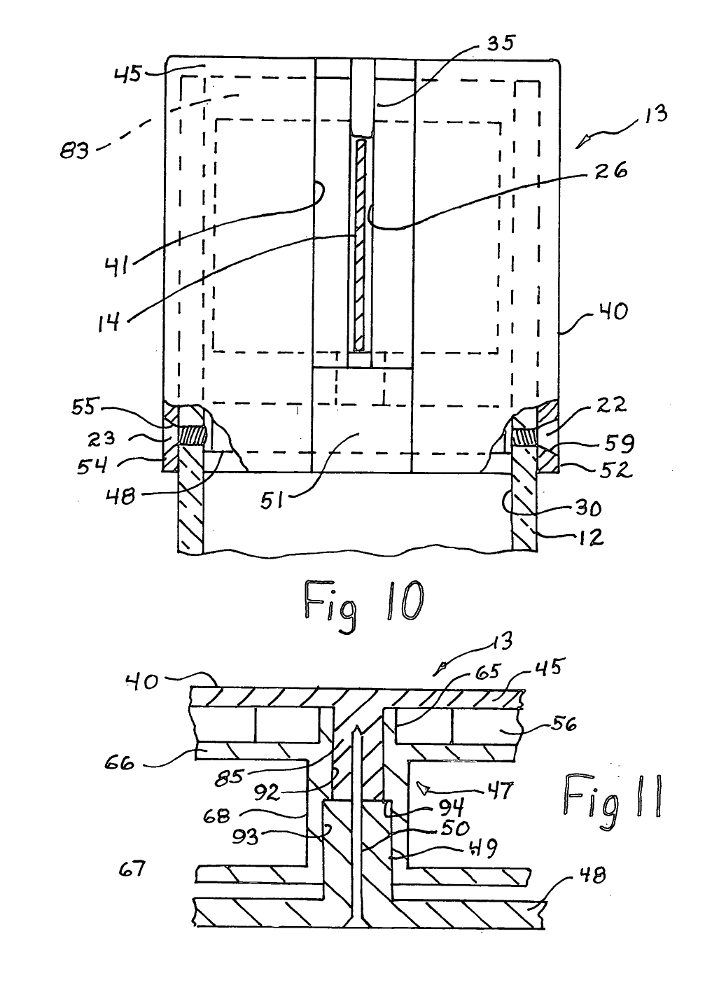

With the lower end of post 12 secured within base 11 by conventional fabrication, post 12 extends upwardly from base 11 in a generally perpendicular direction. In accordance with an important aspect of the present invention, post 12 is formed as a hollow cylindrical post fabricated of a clear or transparent plastic material or the like. Post 12 defines an upper end which in turn defines a vertical slot 26. In further accordance with an important aspect of the present invention, post 10 further includes a generally cylindrical message support tube 24 formed of a convenient material such as flake board, cardboard or plastic upon which a message sleeve 21 is supported. Message sleeve 21 supports one or more visible message elements such as printed lettering or the like. The combination of support tube 24 and message sleeve 21 is inserted into the interior of post 12. When so inserted, the visible elements of message 25 are viewable the clear or transparent walls of post 12. The assembly of safety stanchion 10 is completed by assembling belt reel 13 upon the upper end of post 12. As is better seen in FIG. 5, belt reel 13 supports a quantity of flexible belt 14 having an outer end which is joined to a connector 15. Accordingly, the assembly of belt reel 13 to be the upper end of post 12 includes aligning slot 26 with the portion of belt 14 (seen in FIG. 5) extending from belt reel 13 such that belt 14 passes through slot 26. With the upper end of post 12 seated within the interior of belt reel 13, in the manner shown below in FIG. 10, belt 14 is able to move inwardly and outwardly from belt reel 13 through slot 26. In addition, slot 26 cooperates with an indexing post 35 (seen in FIG. 8) which extends downwardly and serves to provide appropriate alignment of post 12 as index post 35 is inserted into the upper end of slot 26. The cooperation of slot 26 of post 12 and index post 35 of belt reel 13 provides an exact rotational alignment between belt reel 13 and post 12. A pair of conventional fasteners 22 and 23 are passed through apertures formed in the housing of belt reel 13 and engage corresponding apertures formed in the upper end of post 12. Alternatively, fasteners 22 and 23 may be conventional self-tapping type fasteners which simply thread into the material of post 12. Thus, the complete assembly of stanchion 10 is carried forward by simply inserting post 12 into base 11 and thereafter inserting the combination of message sleeve 21 and support tube 24 into post 12 after which belt reel 13 is rotated upon post 12 to align slot 26 with indexing post 35. The assembly is completed by inserting and threading fasteners 22 and 23. In this manner, the entire safety stanchion is easily assembled and disassembled to facilitate operations such as removal and replacement of message sleeve 21 without substantial difficulty or without the need of substantial tools.

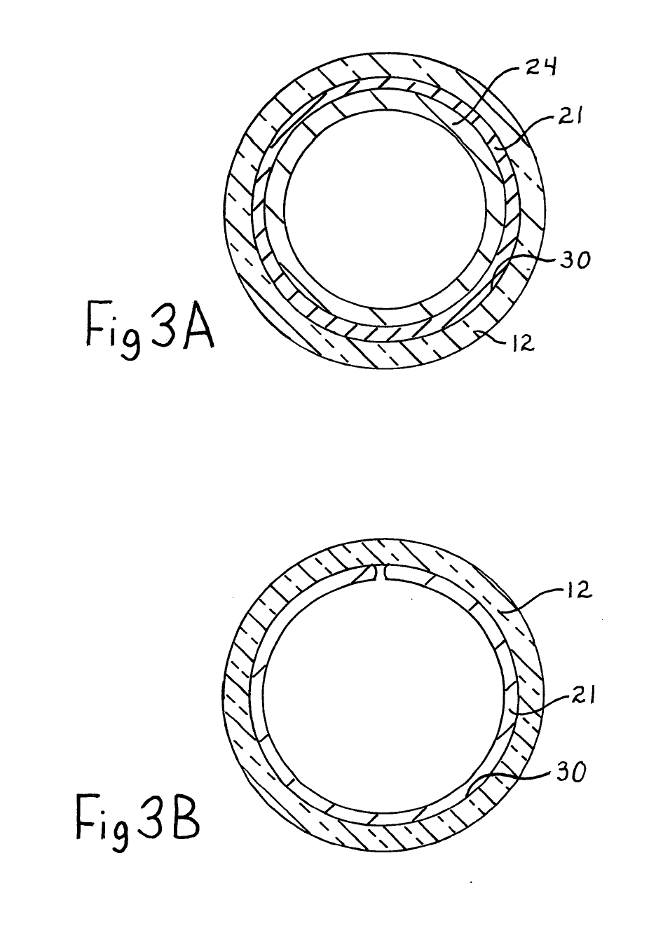

FIG. 3A sets forth a section view of post 12 taken along section lines 3-3 in FIG. 2. As mentioned above, post 12 is preferably formed as a hollow, generally cylindrical post fabricated of a clear or transparent material. It will be noted that while the preferred fabrication of post 12 provides a generally cylindrical post, it will be apparent to those skilled in the art that post 12 may be fabricated using alternative shapes such as square cross section, triangular cross section, rectangular cross section or the like without departing from the spirit and scope of the present invention. Post 12 thus in the embodiment shown in FIG. 2 provides a cylindrical post having a cylindrical interior surface 30. The interior of post 12 supports a message support tube 24 defining a shape generally corresponding to the shape of support post 12. Thus, with support post 12 being fabricated in a generally cylindrical shape, support tube 24 is preferably formed in a similar or corresponding cylindrical shape. Support tube 24 receives a message sleeve 21 upon its outer surface. Alternatively, message sleeve 21 may comprise a sheet of flexible material such as paper or the like upon which the desired message information elements have been printed. In such case, message sleeve 21 is simply wrapped upon the cylindrical outer surface of support tube 24. In either event, the combined structure of support tube 24 and message sleeve 21 are simply inserted into the interior of post 12. Preferably the size of support tube 24 and the thickness of message sleeve 21 are selected to position message sleeve 21 generally in contact with interior surface 30 of post 12.

FIG. 3B sets forth a section view taken along section lines 3-3 in FIG. 2 which illustrates an alternate embodiment of the present invention. As described above, post 12 defines a generally cylindrical post having an interior surface 30. The embodiment of FIG. 3B differs from the embodiment of FIG. 3A in that the use of support tube 24 is avoided in the embodiment of FIG. 3B. In such case, message sleeve 21 is preferably formed of a resilient sheet material having a memory or tendency to flex to a planar configuration when unconfined. Accordingly, with the outer surface of message sleeve 21 baring the desired visible message, sleeve 21 is simply rolled into a generally cylindrical shape and inserted into post 12. Once released, the resilient character of sleeve 21 causes it to flex outwardly against interior surface 30 and thud maintain the desired liner configuration within post 12.

FIG. 4 sets forth a perspective view of belt reel 13 showing the connection of the belt and connector portion of an adjacent safety stanchion (not shown). As described above, belt reel 13 will be understood to support a quantity of belt 14 and connector 15 in the manner shown above in FIG. 1. Belt 14 and connector 15 are omitted from FIG. 4 to avoid obscuring important elements of the structure of belt reel 13.

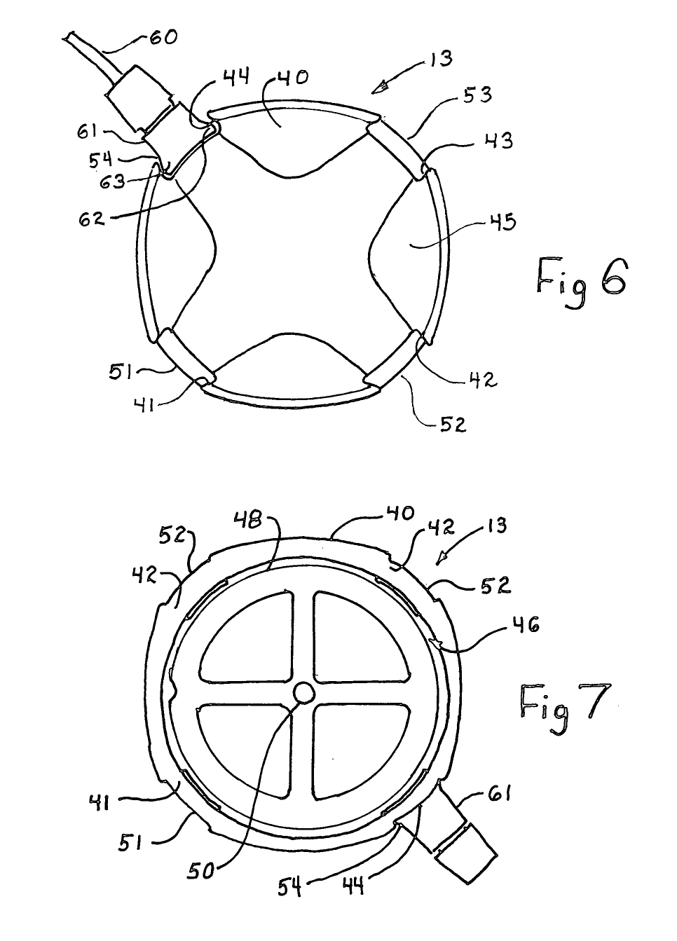

More specifically, belt reel 13 includes a generally cylindrical spool housing 40 defining a generally cylindrical shape having a closed top 45 and an open bottom 46. Housing 40 defines four equally spaced elongated vertical slots 41, 42, 43 and 44. As is better seen in FIG. 6, slots 41 through 44 each define inwardly and outwardly angle surfaces on each side thereof. As is also better seen in FIG. 6, housing 40 defines a plurality of lower wall portions 51, 52, 53 and 54 at the bottom ends of slots 41, 42, 43 and 44 respectively. Housing 40 further defines a downwardly extending index post 35 supported at the upper end of slot 41. The function of index post 35 is described below in conjunction with FIG. 10 in greater detail. However, suffice it to note here that index post 35 is received within slot 26 (seen in FIG. 2) formed in the upper end of post 12 (also shown in FIG. 2). A belt spool 47 is rotatably supported within housing 40 and is captivated in the manner described below by a spool base 48. Wall 54 defines an aperture 55 which receives fastener 23 (seen in FIG. 2). While not visible due to the perspective view of housing 40, it will be understood that slot 42 having wall 52 at the lower end thereof defines a similarly positioned aperture.

In the perspective view of FIG. 4, a belt connector 61 supporting a belt 60 is received within slot 44 of housing 40. Connector 44 is better seen in FIG. 6. However, suffice it to note here that connector 44 defines angled outer edges which are received within slot 44 and which facilitate a sliding engagement of connector 61. Thus, FIG. 4 shows the attachment of an adjacent belt connector from an adjacent safety stanchion to secure belt 60 in attachment to belt reel 13. In this manner, belt 60 is joined to belt reel 13. While not illustrated in FIG. 4, it will be understood that corresponding attachments of additional belt connectors may be slidably received within slots 42 and 43.

Belt spool 47 is rotatably supported within housing 40 of belt reel 13 and normally receives and supports a length of belt 14 (not shown). The rotational support of belt spool 47 is provided at the lower end by a spool base 48. The cooperation of spool base 48 and housing 40 to rotatably support belt spool 47 is shown and described below in FIGS. 8 and 11. However, suffice it to note here that spool base 48 is secured to housing 40 such that belt spool 47 is captivated within housing 40 and rotatably supported therein. To facilitate the smooth withdraw of belt 14 and the smooth rewinding thereof into housing 40, wall 51 within slot 41 is raised into general alignment with the lower end of belt spool 47. Thus, wall 51 extends upwardly within slot 41 a greater distance than walls 52 through 54 extend upwardly into respective slots 42 through 44.

Also seen in FIG. 4 is the connection of an additional belt 60 from a neighboring safety stanchion (not shown) which is accomplished by a connector 61. Connector 61 is fabricated in the manner set forth below in FIG. 6 in greater detail. However, suffice it to note here that connector 61 is secured to the end of belt 60 and is slidably received within a selected one of slots 42, 43 or 44 in spool housing 40. In the example shown in FIG. 4, connector 61 supporting one end of belt 60 is slidably received within slot 44. It will be apparent to those skilled in the art that similar connectors shaped in the manner shown for connector 61 may be slidably received within slots 42 or 43 as desired. Alternatively, a plurality of connectors supporting respective belts may be simultaneously inserted into slots 42, 43 and 44 to provide the desired belt network.

FIG. 5 sets forth a perspective view of belt reel 13 showing belt 14 extending outwardly therefrom. FIG. 5 also shows connector 15 in perspective assembly view and further shows the attachment of the end portion of belt 14 within connector 15.

More specifically, belt reel 13 includes a generally cylindrical spool housing 40 defining a generally cylindrical shape having a closed top 45 and an open bottom 46. Housing 40 defines four equally spaced elongated vertical slots 41, 42, 43 and 44. As is better seen in FIG. 6, slots 41 through 44 each define inwardly and outwardly angle surfaces on each side thereof. As is also better seen in FIG. 6, housing 40 defines a plurality of lower wall portions 51, 52, 53 and 54 at the bottom ends of slots 41, 42, 43 and 44 respectively. Housing 40 further defines a downwardly extending index post 35 supported at the upper end of slot 41. The function of index post 35 is described below in conjunction with FIG. 10 in greater detail. However, suffice it to note here that index post 35 is received within slot 26 (seen in FIG. 2) formed in the upper end of post 12 (also shown in FIG. 2). A belt spool 47 is rotatably supported within housing 40 and is captivated in the manner described below by a spool base 48. Wall 54 defines an aperture 55 which receives fastener 23 (seen in FIG. 2). While not visible due to the perspective view of housing 40, it will be understood that slot 42 having wall 52 at the lower end thereof defines a similarly positioned aperture.

More specifically, belt 14 is shown partially drawn from belt reel 13 by pulling belt 14 in the direction indicated by arrow 80. Connector 15 is shown comprised of a connector portion 70 and a cooperating connector portion 71. Connector portion 70 defines a slot 72 extending through connector portion 70 through which belt 14 extends. The outer end of belt 14 is folded and sewn to form a sleeve 76 which receives an elongated generally cylindrical pin 77. Sleeve 76 and pin 77 cooperate to enlarge the outer end of belt 14 such that sleeve 76 passes into slot 72 but is unable to pass entirely through connector portion 70 and is thus captivated within slot 72. Connector portion 71 is received against connector portion 70 and captivates sleeve 76 within slot 72. Connector portion 70 further defines a pair of apertures 73 and 74 which receive conventional fasteners 78 and 79 respectively. Connectors 78 and 79 engage connector portion 71 securing connector portions 70 and 71 together captivating end sleeve 76 of belt 14.

FIG. 6 sets forth a top view of belt reel 13 having a connector 61 coupling a belt coupling thereto. It will be noted that belt 14 and connector 15 (seen in FIG. 5) are omitted from FIG. 6. As described above, belt reel 13 includes a molded plastic housing 40 defining a plurality of vertical slots 41, 42, 43 and 44 equally spaced about the outer surface of housing 40. As is also described above, the lower edge of slots 41 through 44 include a corresponding plurality of wall portions 51 through 54 respectively. As is also mentioned above, it will be noted that slots 41 through 44 define generally parallel side edges which angle outwardly as they extend into housing 40. The outwardly angled edge surfaces of each of slots 41 through 44 facilitate the sliding engagement of a connector such as connector 61 shown slidably engaged within slot 44. Thus, it will be apparent from FIG. 6 that connector 61 which illustrates a connector from an adjacent stanchion (not shown) defines cooperating angled edges which are received within slot 44 and which engage the angled side edges thereof. Thus, connector 61 coupling belt 60 to belt reel 13 is shown having outwardly angled edges 62 and 63. What is important to note in FIG. 6 is the cooperation of angled edges 62 and 63 of connector 61 secure connector 61 within slot 44. Accordingly, connector 61 is inserted into its connected position as shown in FIG. 6 by aligning connector 61 with the upper opening of slot 44 and thereafter sliding connector 61 downwardly to engage slot 44 in the manner shown above in FIG. 4. It will be equally apparent to those skilled in the art that slot 41 accommodates belt 14 in the manner shown in FIG. 5 leaving the remaining slots (slots 42 and 43) to receive connectors in a similar manner to connector 61 within slot 44. Thus, as is seen in FIG. 6, belt reel 13 is able to extend a belt 14 wound within belt reel 13 in the manner set forth below while concurrently being capable of receiving connector attachments from up to three adjacent stanchions within the pathway of which stanchion 10 (seen in FIG. 1) forms a portion. Thus, a total of four belts may extend outwardly from belt reel 13.

FIG. 7 sets forth a bottom view of belt reel 13 having connector 61 engaged therein. As described above, belt reel 13 includes a molded plastic housing 40 defining a generally cylindrical shape having a closed upper surface 45 and an open end bottom 46. As is set forth below in greater detail, belt reel 13 includes a spool base 48 supported within the interior of housing 40 by a conventional fastener 50. Of importance to note, and as is set forth below in greater detail, fastener 50 is the only fastener utilized in securing the complete assembly of belt reel 13. Correspondingly, the disassembly of belt reel 13 is carried forward by simply removing a single fastener (fastener 50). This greatly facilitates repair and assembly of the present invention belt reel.

FIG. 8 sets forth a perspective assembly view of belt reel 13. It will be noted that belt reel 13 is fabricated utilizing a minimum number of components. Thus, belt reel 13 is formed of a housing 40, a spring 56, a belt spool 47 and a spool base 48.

As described above, housing 40 is preferably formed of a molded plastic housing having a generally cylindrical shape and a closed upper surface 45. As is also described above, housing 40 is generally cylindrical and generally hollow defining an open bottom end 46. Housing 40 further defines a plurality of vertical slots 41 through 44. Slots 41 through 44 terminate at their lower ends in wall portions 51 through 54 respectively. Wall 52 of slot 42 further defines an aperture 59 which functions in a similar manner to aperture 55 in wall 54 (seen in FIG. 4) to receive fasteners utilized in the manner set forth above in FIG. 2 to secure housing 40 of belt reel 13 to generally cylindrical post 12. Slot 41 is the slot which facilitates the passing of belt 14 (seen in FIG. 5) from within housing 40 to the exterior thereof. Thus, slot 41 differs from slots 42 through 44 in that wall portion extends upwardly a greater distance and a downwardly extending index post 35 is formed at the upper end of slot 41. It will be recalled that increased wall 51 provides for better control of the belt within belt reel 13 as it is drawn from and wound within housing 40. It will be further recalled that indexing post 35 is received within a slot 26 (seen in FIG. 2) formed in the upper end of post 12. Indexing post 35 and slot 26 cooperate to maintain a fixed rotational position and to provide a referencing index position as post 12 is assembled to belt reel 13 in the manner described above in FIG. 2.

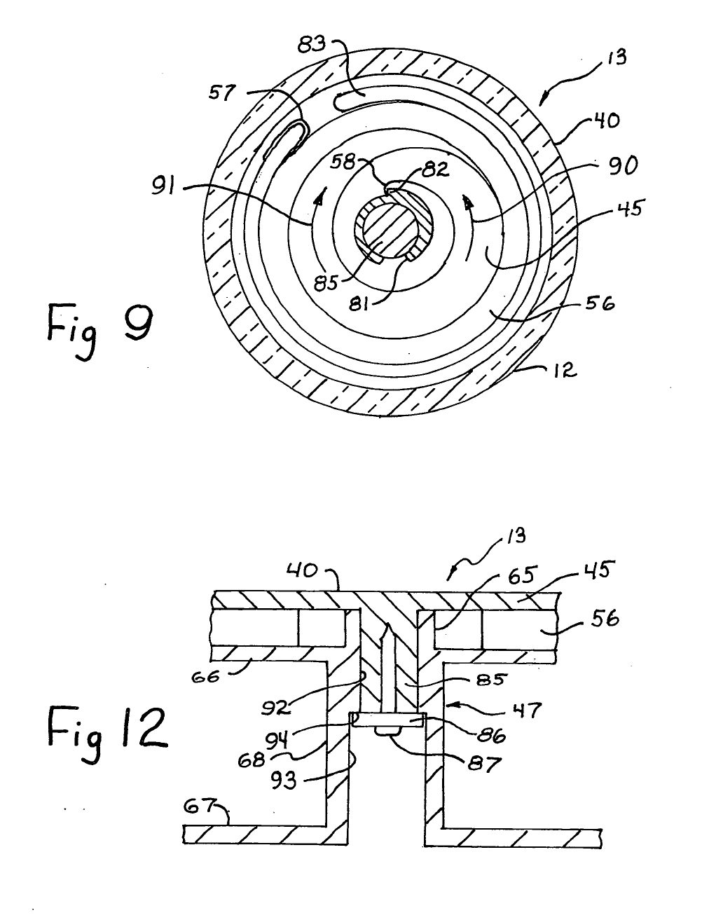

Belt reel 13 further includes a spring 56 having an outer end hook 57 and an inner end hook 58. Belt spool 47 receives and supports belt 14 (seen in FIG. 5). Belt 14 is omitted from FIG. 8 to avoid obscuring other structural details of spool 47. Thus, spool 47 includes a center axle 48 supporting a pair spaced apart generally circular flanges 66 and 67. An elongated pin 69 extends between flanges 66 and 67 and is operative to secure the inner end of belt 14 when belt 14 is wound upon spool 47 in the manner shown in FIG. 5. Spool 47 further defines an upwardly extending bearing 65 which, as is better seen in FIG. 9, engages inner hook 58 of spring 56 when spring 56 is assembled to belt spool 47. Spool base 48 provides a generally circular base supporting an upwardly extending lower spool guide 49. Spool guide 49 is generally cylindrical and, as is better seen in FIG. 11, is received within the lower portion of axle 68 of belt spool 47.

Thus, belt reel 13 is assembled by initially winding belt 14 (seen in FIG. 5) upon axle 68 of belt spool 47. Thereafter, spring 56 is positioned within housing 40 beneath upper surface 45 in the manner shown in FIG. 9. When so positioned, and as is seen in FIG. 9, outer hook 57 engages a corresponding engagement within the upper end of housing 40. Thereafter, belt spool 47 is positioned within housing 40 such that bearing 65 is received within the inner coil of spring 56. Finally, spool base 48 is assembled to belt spool 47 by inserting lower spool guide 49 therein in the manner shown in FIG. 11. Thereafter, fastener 50 (seen in FIG. 11) is passed upwardly through spool base 48 to engage upper spool guide 85 (seen in FIG. 11). At this point, belt spool 47 is rotatably supported within housing 40 and is rotated to facilitate engagement of bearing 65 with inner hook 58 of spring 56 in the manner shown in FIG. 9. As a final assembly step, the outer end of belt 14 (seen in FIG. 5) is drawn outwardly through slot 41 in the manner shown in FIG. 5 and connector 15 (also shown in FIG. 5) is assembled to the outer end of belt 14. The ease and simplicity of the present invention structure provides assembly and disassembly utilizing a single fastener together with the attachable connectors for the outer belt end.

FIG. 9 sets forth a section view of stanchion 10 taken along section lines 9-9 in FIG. 4. Returning to FIG. 4 temporarily, it is intended that section line 9-9 is taken above flange 66 of belt spool 47. The purpose of FIG. 9 is to show the attachment of spring 56 between spool 47 and housing 40.

Returning to FIG. 9, belt reel 13 includes a generally cylindrical housing 40 defining a closed upper surface 45. As is better seen in FIG. 11, housing 40 further includes a downwardly extending generally cylindrical upper spool guide 85. As is also better seen in FIG. 11, belt spool 47 is received within the interior of housing 40 such that the upper portion of belt spool 47 is received upon upper guide 85. In the section view of FIG. 9, bearing 65 which extends upwardly from flange 66 of belt spool 47 (seen in FIG. 8) is received upon upper guide 85. Bearing 65 is generally cylindrical in structure and also defines a gap 81 and an outwardly extending spring engage 82. In the preferred fabrication of the present invention, spring engagement 82 is formed to define an engagement tooth which receives and engage spring hook 58 of spring 56. Housing 40 also defines a downwardly extending generally cylindrical wall 83 defining a gap forming an edge 84 therein. Spring 56 is positioned against surface 45 of housing 40 such that spring hook 57 is received upon edge 84 in the engagement shown. Thereafter, belt spool 47 is inserted into housing 40 such that upper spring guide 85 is received within spool 40 in the manner shown in FIG. 11. When so assembled, upper guide 85 passes through bearing 65 of belt spool 47. As belt spool 47 is rotated, spring hook 58 of spring 56 engages spring engagement 82. As described above in conjunction with FIG. 8, the captivation of belt spool 47 is completed by assembling spool base 48 thereto and securing spool base 48 using a fastener 50 as shown in FIG. 11. As belt spool 47 is rotated upon upper guide 85 in the direction indicated by arrow 90, spring 56 is wound ever more tightly. As a result, spring 56 provides a restoring force in the direction indicated by arrow 91. Once the desired degree of preloading upon spring 56 is obtained by rotation in the direction indicated by arrow 90, the end portion of belt 14 is drawn outwardly through slot 41 of housing 40 in the manner shown in FIG. 5. Once connector 15 if assembled to the out end of belt 14 as shown in FIG. 5, connector 15 is released and the restoring force of spring 56 in the direction indicated by arrow 91 draws connector 15 toward housing 40. Thereafter, withdrawing belt 14 winds spring 56 in the direction indicated by arrow 90 and releasing belt 14 allows the restoring force of spring 56 operative in the direction indicated by arrow 91 to wind belt 14 upon spool 47.

FIG. 10 sets forth a partial section view of the upper portion of safety stanchion 10 showing the attachment of belt reel 13 to the upper end of post 12. As described above, post 12 defines a generally cylindrical post formed of a clear transparent material such as clear or transparent plastic or the like. As is also described above, post 12 may be shaped in alternative shapes rather than the cylindrical shaped example shown for purposes of illustration herein. Post 12 defines a hollow cylindrical body having an inner surface 30 and an elongated slot 26. Slot 26 extends downwardly from the upper end of post 12.

Belt reel 13 includes a housing 40 which receives the upper end of post 12 such that the upper end of post 12 contacts the interior of closed end 45 of housing 40. Housing 40 further includes a downwardly extending wall 83 which is received within the interior of post 12. Housing 40 further includes a downwardly extending index post 35 which is received within the upper portion of slot 26. In the manner described below, spool 47 supporting belt 14 is received within housing 40 such that the outer end of belt 14 extends through slot 26 of post 12. Housing 40 further defines a slot 41 positioned in alignment with slot 26 of post 12. A wall portion 51 forms the bottom of slot 41. As is also described above, spool base 48 is received within housing 40 and secures spool 47 in a freely rotatable captivation. Housing 40 further defines wall portions 52 and 54 which define respective apertures 59 and 55. A pair of threaded fasteners 22 and 23 are passed through apertures 59 and 55 and threadably engage apertures in post 12. In this manner, belt reel 13 is secured to the upper end of post 12. Once again, it will be noted that the cooperation of slot 26 of post 12 and index post 35 maintains the rotational position of belt reel 13 upon post 12.

FIG. 11 sets forth a partial section view of belt reel 13 showing the attachment of spool base 48 to housing 40 and the captivation of spring 56 and belt spool 47 within housing 40. More specifically, housing 40 defines an upper closed end 45 having a downwardly extending generally cylindrical upper spool guide 85 formed therein. Belt spool 47 defines a pair of spaced apart flanges 66 and 67 joined to respective ends of a cylindrical axle 68. Axle 68 defines a reduced diameter bore 92 and an expanded diameter bore 93 which are generally coaxial in alignment. The size difference between bores 93 and 92 results in the creation of an edge 94 therebetween. Bore 92 is sized to receive upper spool guide 85 in a relatively close fit while allowing rotation of spool 47 upon upper spool guide 85. Similarly, spool base 48 having a generally cylindrical lower spool guide 49 is assembled to housing 40 such that spool guide 49 passes upwardly through bore 93 and abuts edge 94. A fastener 50 is passed upwardly through spool base 48 and spool guide 49 thereof to engage the lower portion of spool guide 85. Fastener 50 secures the upper surface of spool guide 49 against the lower end of spool guide 85. Thus, spool base 48 is secured to spool guide 85 and housing 40 by fastener 50. The sizes of bores 92 and 93 with respect to spool guides 85 and 49 allows spool 47 to be freely rotatable thereon. Additionally, edge 94 allows spool 47 to rest upon the upper end of spool guide 49. As a result, spool 47 is freely rotatable upon edge 94 and bearing 65 within housing 40 and spool base 48.

FIG. 12 sets forth a partial section view of an alternate embodiment of belt reel 13 showing the attachment of a washer 86 and fastener 87 to housing 40 and the captivation of spring 56 and belt spool 47 within housing 40. More specifically and as is set forth above in FIG. 11, housing 40 defines an upper closed end 45 having a downwardly extending generally cylindrical upper spool guide 85 formed therein. Belt spool 47 defines a pair of spaced apart flanges 66 and 67 joined to respective ends of a cylindrical axle 68. Axle 68 defines a reduced diameter bore 92 and an expanded diameter bore 93 which are generally coaxial in alignment. The size difference between bores 93 and 92 results in the creation of an edge 94 therebetween. Bore 92 is sized to receive upper spool guide 85 in a relatively close fit while allowing rotation of spool 47 upon upper spool guide 85. The embodiment of FIG. 12 differs from the embodiment of FIG. 11 in that a washer 86 and fastener 87 replace spool base 48 and fastener 50. Washer 86 is inserted into bore 93 against edge 94 and is held by fastener 87. Fastener 87 also secures washer 86 against the lower end of spool guide 85. The size of bore 92 and spool guides 85 allows spool 47 to be freely rotatable thereon. As a result, spool 47 is freely rotatable upon edge 94 and bearing 65 within housing 40 without the need for spool base 48 (shown in FIG. 11).

What has been shown is a safety stanchion and belt reel used therein which cooperate to provide an improved safety stanchion for use in various venues in which a flexible pathway or network arrangement of pathways is to be provided by a plurality of stanchions and interconnecting belts. The inventive safety stanchion set forth herein is readily fabricated of relatively inexpensive molded plastic parts and provides for the advantageous display of various visible messages such as informational directions or advertising materials. The safety stanchion described herein is assembled or disassembled using a single fastener and a minimum of component parts.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

1. A safety stanchion comprising:
a base;
a hollow post formed of a light transmissive material having a first end joined to said base and extending vertically from said base, said post having second end defining an upper edge and an interior passage between said ends;
a belt reel having a housing defining an interior, an open bottom end and a closed top end, said housing receiving said second end within said interior such that said upper edge is against said closed top end and a rotatably supported belt spool within said second end of said hollow post and said housing interior;
a length of flexible belt defining a belt width and having a first end coupled to said belt spool, a portion wound upon said belt spool and a second end extending outwardly from said housing;
a return spring within said housing coupled to said belt spool urging said belt spool toward winding said belt;
a belt connector secured to said second end of said flexible belt; and
a message element having visible indicia thereon said message element being supported within said interior passage such that said visible indicia are visible through said post.

2. The safety stanchion set forth in claim 16 wherein said hollow post is generally cylindrical and wherein said message element includes:
a generally cylindrical support tube sized to be receivable within said center passage; and
a pliable sheet of media material having said visible indicia thereon,
said pliable sheet being wrapped upon said support tube and inserted into said center passage.

3. The safety stanchion set forth in claim 2 wherein said hollow post is formed of clear material.

4. The safety stanchion set forth in claim 3 wherein said visible indicia include advertising information.

5. The safety stanchion set forth in claim 3 wherein said visible indicia include directional information.

6. The safety stanchion set forth in claim 16 wherein said message element includes a generally planar sheet having said visible indicia thereon, said generally planar sheet being inserted into said center passage.

7. The safety stanchion set forth in claim 6 wherein said hollow post is generally cylindrical and wherein said generally planar sheet is formed of a resilient material, said sheet being formed into a sleeve and inserted into said center passage and spring outwardly against said hollow post.

8. The safety stanchion set forth in claim 7 wherein said hollow post is formed of clear material.

9. The safety stanchion set forth in claim 8 wherein said visible indicia include advertising information.

10. The safety stanchion set forth in claim 8 wherein said visible indicia include directional information.

11. A safety stanchion comprising:
a base;
a post having a first end joined to said base and a second end defining a downwardly extending slot, said post extending upwardly from said base;
a belt reel housing, supported upon said upper end having an interior, an open bottom, a closed top, an index post extending onto said slot and an upper spool guide therein, said second end of said post extending through said open bottom into said interior to said closed top;
a belt spool having a bore therein, said spool being rotatably supported by said upper spool guide extending into said bore;
a spool base defining a planar base portion and an upwardly extending lower spool guide, said lower spool guide extending into said bore to meet said upper spool guide, said spool base and said housing captivating said belt spool in a rotatable support;
a fastener extending through said lower spool guide engaging said upper spool guide;
a spring supported within said housing engaging said belt spool;
a length of flexible belt having a first end joined to said belt spool, a portion wound upon said belt spool and a second end extending outwardly from said housing through said slot in said hollow post; and
a belt connector secured to said second end of said belt,
said spring providing a rewind force against said belt spool urging said belt spool toward winding said flexible belt upon said belt spool, and said belt spool, said spool base, said fastener, said spring and said flexible belt being enclosed within said belt reel housing and said second end of said post.

12. The safety stanchion set forth in claim 11 wherein said post is formed a hollow transparent tube and wherein said post further includes a message tube having a visible indicia thereon, said message tube received within said hollow transparent tube such that said visible indicia are visible through said transparent hollow tube.

13. The safety stanchion set forth in claim 12 wherein said visible indicia include advertising information.

14. The safety stanchion set forth in claim 12 wherein said visible indicia include directional information.

15. A safety stanchion comprising:
a base;
a post having a first end joined to said base and a second end defining an upper edge, said post extending upwardly from said base;
a belt reel housing having a closed top surface, an interior and an upper spool guide extending downwardly therein, said second end extending into said interior to said closed top;
a belt spool having an upper bore and a lower bore therein, said upper and lower bores meeting to define an edge therebetween and said spool being rotatably supported by said upper spool guide extending into said upper bore;
a washer having a dimension greater than said edge received within said lower bore against said edge;
a fastener extending through said washer engaging said upper spool guide and captivating said belt spool in a rotational support upon said upper spool guide;
a spring supported within said housing engaging said belt spool;
a length of flexible belt having a first end joined to said belt spool, a portion wound upon said belt spool and a second end extending outwardly from said housing; and
a belt connector secured to said second end of said belt,
said spring providing a rewind force against said belt spool urging said belt spool toward winding said flexible belt upon said belt spool and said belt spool, said washer, said fastener, said spring and said flexible belt being enclosed within said second end and said interior.

16. The safety stanchion set forth in claim 1 wherein said upper end of said hollow post defines a slot extending downwardly from said upper edge of said hollow post and wherein said housing includes an index post extending downwardly from said closed top end of said housing into said slot to index the position of said housing upon said hollow post.
